(19) United States
(12) Patent Application Publication
(10) Pub. No.: US 2004/0041835 A1
(43) Pub. Date: Mar. 4, 2004

(54) Novel web site player and recorder

(76) Inventor: Qiu-Jiang Lu, Mountain View, CA (US)

Correspondence Address: QIU-JIANG LU, 725 MARIPOSA AVENUE #107, MOUNTAIN VIEW, CA, 94041, US

(21) Appl. No.: 10/233,651

(22) Filed: Sep. 3, 2002

(51) Int. Cl. G09G 5/00

(52) U.S. Cl. 345/748; 345/809

(57) ABSTRACT

The present invention provides and utilizes a novel finding that the vastly scattered remote Internet content, although very different than the local physical VCR or DVD medium, can be automatically and continuously displayed (i.e. playable). A method is provided to turn a web browser into a web site player whose operation is similar to that for a VCR or a DVD player. That is, a user presses a button, sits back, and watches an entire web site played page by page. Recording, forward display and backward display of web pages within a web site are practiced by building a sequence of web page addresses and performing an automatic continuous consecutive display for the web pages whose addresses are contained in the sequence.

### CROSS-REFERENCE TO RELATED APPLICATIONS

Not Applicable

### FEDERALLLY SPONSORED RESEARCH

Not Applicable

### SEQUENCE LISTING OR PROGRAM

Not Applicable

### BACKGROUND OF THE INVENTION

1. Field of the Invention

This invention relates to a method for displaying and recording Internet resources and, more particularly, to a method for automatically and continuously displaying and recording HTML-based Internet content.

2. Description of the Related Art

The most common mechanism to access Internet or World Wide Web (“web”) content today is through the use of a personal computer and a web browser (e.g. INTERNET EXPLORER from Microsoft and NAVIGATOR from Netscape, Inc.). Much of that Internet content is accessible as or via HTML-based (Hypertext Markup Language) web pages. HTML provides a standard set of tags that define how a web page is to be displayed.

Each web page is uniquely identified by an “address” or Uniform Resource Locator (“URL”). To view a specific web page with a browser, a user specifies the URL for that web page, and the browser initiates a request to a web server using the URL. The web server responds by sending the requested content, usually in HTML, to the browser. This process of obtaining a web page (or other resources) from a web server is normally called “download”. Once receiving the HTML data, the browser processes it and displays the Internet content as a graphical web page. Often these web pages have hyperlinks embedded in the web page, which allow the user to request further Internet content. These hyperlinks are also URLs, which tell the browser where to find the content. By manually selecting hyperlinks, the user tells the browser to navigate to other web pages. Some browsers or non-browser applications may provide functions to automatically download a plurality of web pages for off-line browsing, but the user still has to manually navigate through the pages.

In some special cases where web masters want to automatically present a series of predetermined web pages for very specific purposes such as showing a portfolio, special software modules embedded in web pages are developed to automate the processes. One problem with this kind of automation is the requirement of developing the special software modules for each individual web site. Therefore, the automation is not readily and widely available. The present art fails to recognize the usefulness of automatically and continuously displaying web pages for all Internet web sites, and does not have methods to exploit the usefulness.

One problem with conventional Internet navigation is inefficient for viewing a large number of web pages within a web site. For example, if a web site contains hundreds of web pages, it is very difficult for a visitor to browse through all the pages and discover the most useful information.

Another problem is that the variation in the look, feel and functionality of many different sites may pose an obstacle to a novice user. Unlike the easy and familiar operation for a VCR or a DVD player, viewing inconsistent web sites may present a significant impediment to using Internet resources.

3. Objects of the Invention

The present invention recognizes and utilizes a novel finding that the vastly scattered remote Internet content, although very different than the local physical VCR or DVD medium, can be automatically and continuously displayed (i.e., “playable”). Instead of saying “automatically and continuously display, page by page, a sequence of web pages within a web site,” it is more succinct and understandable to say “play a web site”. An object of the invention is to provide a novel method to turn a web browser into a “web site player” whose operation is similar to that for a VCR or a DVD player. That is, a user presses a button, sits back, and watches an entire web site played page by page.

A still further object of the invention is to provide a novel method for stopping the web site play process (“Stop”), continuing the play process (“Forward Play”), and reversing the play process (“Backward Play” or “Rewind”).

A still further object of the invention is to provide a novel method for guiding the web site player to play along a sequence of URLs within a web site or across different web sites.

A still further object of the invention is to provide a novel method for automatically and continuously displaying web pages without the requirement of developing special software modules for each individual web site.

A still further object of the invention is to provide a novel method for recording information or content while the content is being played. Hereafter, the web site player and recorder are simply referred to as “web site player” for short.

Still further objects and advantages of the invention will become apparent from a consideration of the following description and drawings.

### SUMMARY OF THE INVENTION

A method is provided to turn a web browser into a web site player whose operation is similar to that for a VCR or a DVD player. Recording, forward display and backward display of web pages within a web site are practiced by building a sequence of web page addresses and performing an automatic continuous consecutive display for the web pages whose addresses are contained in the sequence.

### BRIEF DESCRIPTION OF THE DRAWINGS

These and other more detailed and specific features of the present invention are more fully disclosed in the following description, reference being had to the accompanying drawings, in which:

FIG. 1 illustrates an example of a web site player toolbar integrated into a web browser.

FIG. 2 is a group of buttons embedded in a web site player toolbar.

FIG. 3 illustrates a sequence of web page addresses for controlling the play position and direction.

FIG. 4 is a flowchart illustrating the steps performed when a web site player is in operation.

### DETAILED DESCRIPTION OF THE INVENTION

In the following description, for purposes of explanation, details are set forth, such as a toolbar button layout and a flowchart, in order to provide an understanding of one or more embodiments of the present invention. However, it is and will be apparent to one skilled in the art that these specific details may not be the only configuration in order to practice the present invention.

A web browser (e.g. INTERNET EXPLORER) may support a so-called browser plug-in, which is a separate software module to be loaded and integrated into the browser at run time. Once running inside the browser, the plug-in can control the operation of the browser. The web site player may typically be implemented as a browser plug-in for an existing web browser. But, for a new custom developed web browser, it may also be directly integrated into the browser.

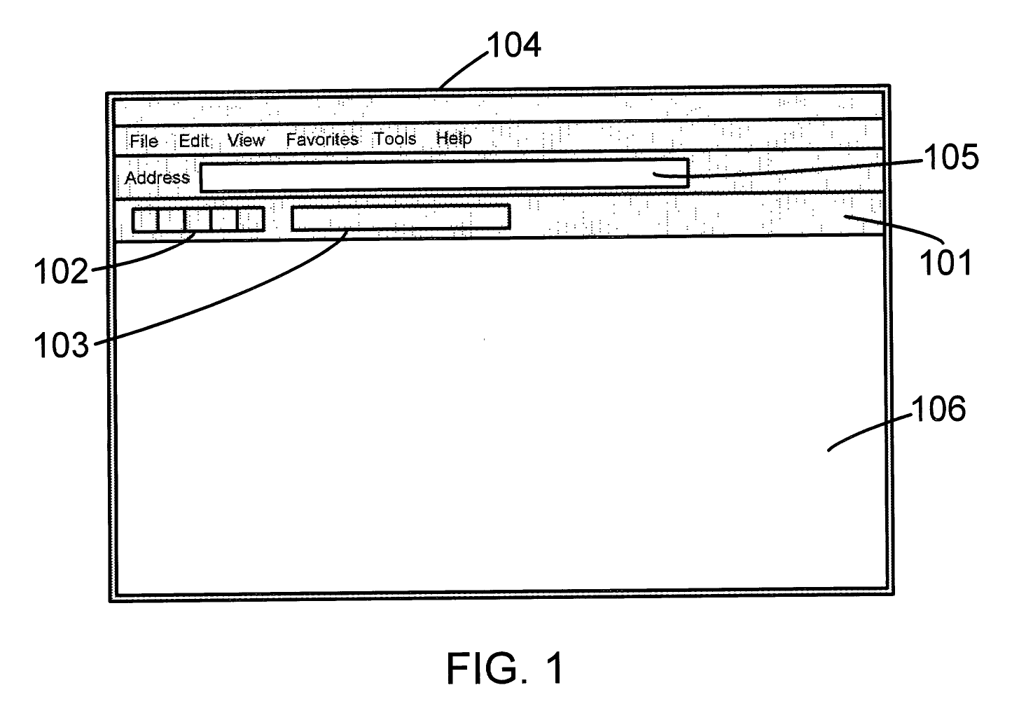

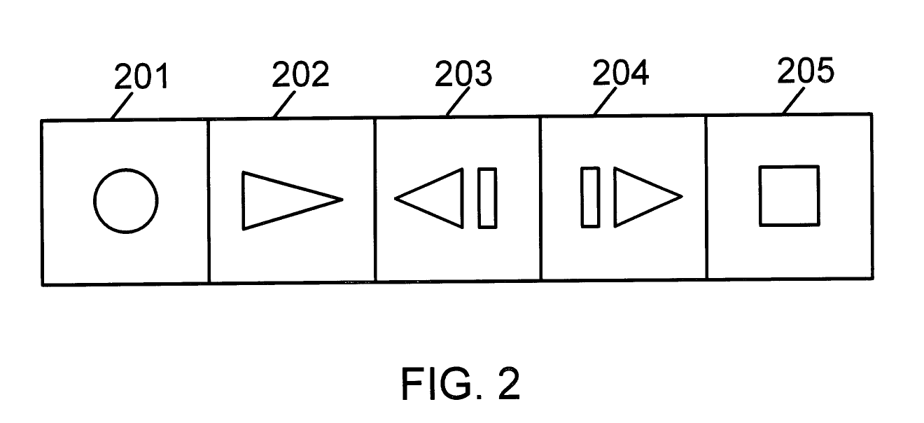

A preferred embodiment of the present invention is illustrated in FIG. 1. The web site player may be practiced as a browser plug-in and appear as a toolbar 101 embedded in a web browser 104. The browser has an address text box 105 and a display area 106 for displaying a web page. The toolbar may have a panel 103, which contains some graphical elements (not shown) such as a progress bar (for displaying the play progress status) and a label (for showing the number of web pages played). Also, the toolbar has a button group 102 whose enlargement is illustrated in FIG. 2. One skilled in the art would appreciate that the horizontal toolbar may be substituted by a vertical bar or the equivalent.

FIG. 2 illustrates a group of buttons for operating the web site player. After navigating to a web page via a hyperlink or by entering a web page address into the address text box 105 (in FIG. 1), to start a play process, a user presses a “Play” button 202. To stop the play process, the user presses a “Stop” button 205. To continue the play process, the user presses a “Forward Play” button 204. To continue the play in a reverse direction, the user presses a “Backward Play” button 203. To record the content, the user presses a “Record” button 201. One skilled in the art would appreciate that these various buttons can be omitted or rearranged or adapted in various ways. For instance, if the Play button performs both playing and recording, the Record button can be omitted.

An “entry address” will be used below, and is defined as the address of the currently displayed web page at the moment when the user presses the Play button. The web page corresponding to the entry address is defined as “entry web page”. After navigating to a web page via a hyperlink or by entering a web page address into the address text box, a user presses the Play button and produces an entry address. The entry address defines the entry point into the web site, and can be used to determine the download scope for the web site being played, as described below.

A web page address typically contains a path and a document name. For instance, the path for a web page address of http://www.xzy-sports.com/soccer/WorldCup/index.html is http://www.xzy-sports.com/soccer/WorldCup/; and the document name is index.html. If a web page address does not explicitly contain a document name, a default name (e.g. index.html) is usually used. If the path of a web page address is the same as or under that of the entry address, the page is defined as being within the scope of the entry address. Otherwise, the page is defined as being outside the scope of the entry address. For instance, if the entry address is http://www.xzy-sports.com/soccer, an address of http://www.xzy-sports.com/soccer/WorldCup/index.html is within the scope of the entry address. But, an address of http://www.xzy-sports.com/travel/index.html is outside the scope. The web site player may display web pages that are within the entry address scope and ignore those that are outside the scope.

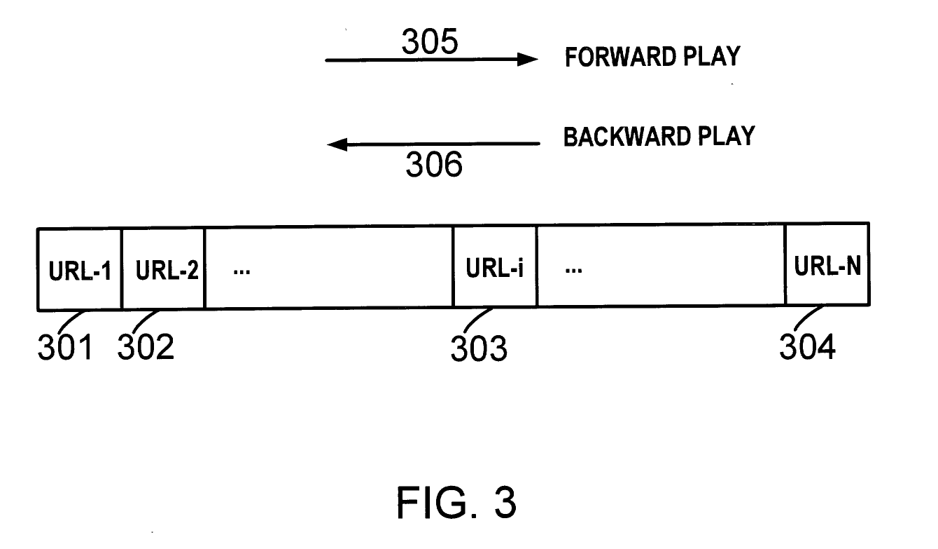

FIG. 3 shows a web page address sequence, which is dynamically built during the play process and is typically stored in a memory. The position of each address within the sequence may be identified by an index number, ranging from 1 to N. The index number for the first address in the sequence is 1, and the index number for the last address in the sequence is N, which may be increased during the play process. It is noted that an index number other than 1 may be used for the first address in the sequence. For example, the index number range can be 0 to N−1.

After navigating to a web page via a hyperlink or by entering a web page address into the address text box, a user presses the Play button and produces an entry address. The address sequence is then cleared or reset, and the entry address is placed as the first address URL-1 (301) in the sequence. The plug-in module scans the entry web page for hyperlink addresses. If the hyperlink addresses are within the entry address scope and are not yet present in the address sequence, they will be appended to the sequence. After the first web page has been played, the next address URL-2 (302) is used to download and display the corresponding web page. If the web page contains more hyperlinks that are within the entry address scope and are not yet present in the sequence, the hyperlink addresses will be further appended to the sequence. This process consecutively proceeds along the sequence until no more new hyperlink addresses are added to the sequence, and the last address URL-N (304) is reached and displayed.

Once the address sequence is built, the play position within the sequence can be flexibly adjusted. For instance, if the play process is stopped at a current address URL-i (303), the Backward Play is realized by continuously and consecutively decreasing the current address index, as indicated by an arrow 306. Whereas, the Forward Play is realized by continuously and consecutively increasing the current address index, as indicated by an arrow 305. If the panel 103 (in FIG. 1) contains a text box (not shown) for the user to enter a position index, the user can select to jump to any position within the sequence.

It is noted that the address sequence can be re-built with a different set of web page addresses for a different web site. This allows a user to switch and play different web sites. It is also noted that the address sequence can be re-built with a different set of web page addresses for a different entry address within the same web site. This allows a user to play different portions of the same site.

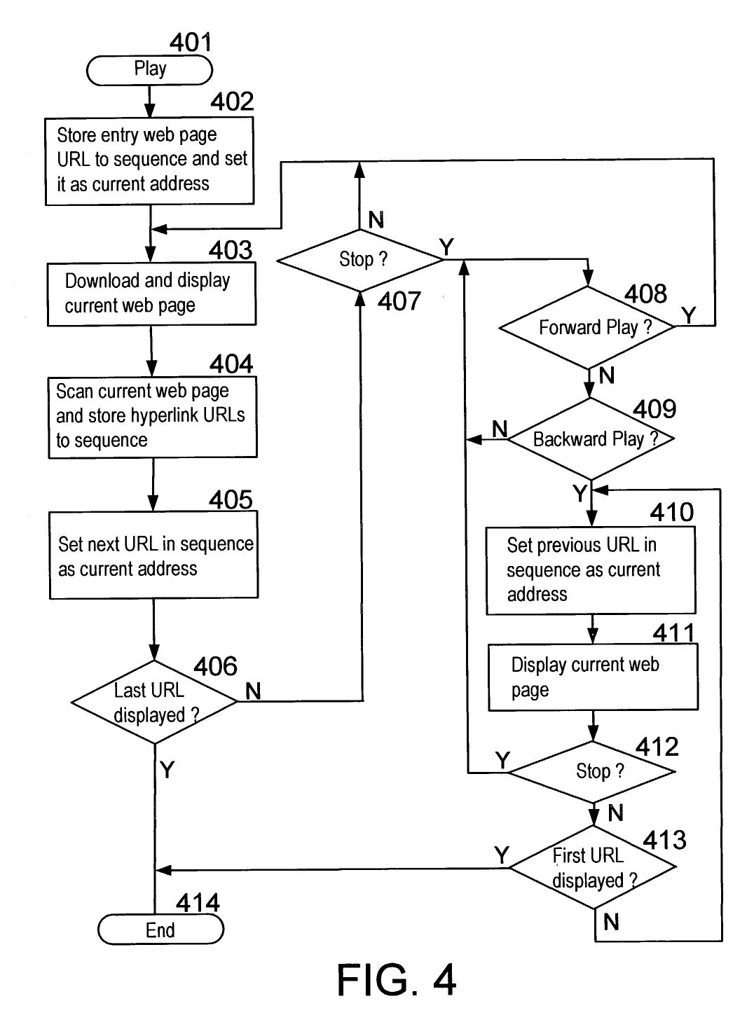

FIG. 4 presents a flowchart illustrating the steps performed when the web site player is in operation. After navigating to a web page and seeing the content, a user may decide to initiate the play process by pressing the Play button (step 401). The web page address then becomes the entry address placed as the first address in the address sequence, and is set as the current address for web page download and display (step 402). If not yet displayed, the current page is then downloaded and displayed (step 403). Then, the current page is scanned for hyperlink addresses. If there are hyperlink addresses that are within the entry address scope and are not yet present in the address sequence, these hyperlink addresses are added to the sequence (step 404). The next address after the current address in the sequence is then set as the current address (step 405). A check is performed to determine whether the last address in the sequence has been displayed (step 406). If yes, the play process ends (step 414). Otherwise, a check is performed to determine whether the Stop button has been pressed (step 407). If no, the process returns to step 403. Otherwise, a check is performed to determine whether the Forward Play button has been pressed (step 408). If yes, the process returns to step 403. Otherwise, a check is performed to determine whether the Backward Play button has been pressed (step 409). If no, the process returns to step 408. Otherwise, a backward play has been initiated and the previous address before the current address in the sequence is set as the current address (step 410). Then, the current page is displayed (step 411). A check is performed to determine whether the Stop button has been pressed again (step 412). If yes, the process returns to step 408. Otherwise, A check is performed to determine whether the first address in the sequence has been reached and displayed (step 413). If yes, the process ends (step 414). Otherwise, the process returns to step 410.

If the recording of the web site content is needed, it can be performed during the play process at step 403. Each time a web page is displayed, its content can be saved to a storage medium for later off-line play or browsing.

Another method for recording is directly save the address sequence (in FIG. 3) to a storage medium without actually saving the web site content. Later, the sequence data is directly loaded from the storage medium to form the address sequence as shown in FIG. 3, without re-building the sequence by scanning web pages for hyperlink addresses and determining the addresses' scopes relative to the entry address. Once the address sequence is formed, a variety of operations (e.g. Play, Stop, Forward Play, Backward Play, and Jump) can be performed.

There is another method to build the address sequence. It is noted that playing different web site content is realized by building the address sequence with a different set of web page addresses. So, a set of web page addresses may be directly provided to purposely guide the web site player to play the specified content. A proprietary tag may be introduced and embedded within a web page. The tag contains a list of web page addresses to be displayed. When the web page is visited by a browser, the plug-in module may scan the web page and detect the tag, and change the icon color of the Play button to inform the user that prearranged content is available for play. If the user presses the Play button, the address list contained in the tag is used to form the address sequence in FIG. 3, and the play process is initiated (same as step 401 in FIG. 4). It is noted that the web page addresses contained in the tag may be within the same web site or across different web sites.

There is still another method to build the address sequence. A list of web page addresses may be stored in a predetermined file under a predetermined web server directory. When a browser visits a web site having such a file, the plug-in module may detect the file and change the icon color of the Play button to inform the user. If the user presses the Play button, the address list contained in the file is used to form the address sequence.

It is noted that the equivalent operation for any one of the buttons in FIG. 2 can be alternatively realized by different methods including but not limited to a sound generated by a user, using a television remote control, depressing of a key on a key pad, and using a pointing device.

Thus, methods for a web site player and recorder have been provided in accordance with the present invention. Although the invention has been described in detail with reference to certain embodiments thereof, other embodiments are possible. For instance, although one embodiment may contain steps as shown in FIG. 4, more or less steps may be provided for a similar overall functionality. Therefore, the spirit and scope of the appended claims should not be limited to the description of the preferred embodiments contained herein.

What is claimed is:

1. A method for providing a web site player that automatically and continuously displays web pages within a web site, the method comprising:
providing a software module that implements a group of buttons contained in a toolbar, which is integrated into a web browser;
providing a sequence of web page addresses that are corresponding to web pages to be displayed;
performing an automatic continuous consecutive forward display or backward display for web pages whose addresses are contained in said sequence, in cooperation with said buttons;
stopping the automatic continuous consecutive forward display or backward display with one of said buttons; and
re-building said sequence with a different set of web page addresses for a different web site,
whereby a user can sit back and watch a web site played page by page, and whereby the user can switch and play different web sites without requiring special software modules for each individual web site.

2. The method of claim 1 wherein the web page addresses contained in said sequence are used to perform an automatic continuous consecutive forward display or backward display of the corresponding web pages.

3. The method of claim 1 wherein the automatic continuous consecutive forward display or backward display is operated with said buttons that are embedded in a web browser toolbar rather than in a web page.

4. A method for initiating and controlling an automatic continuous consecutive forward display or backward display for a sequence of web pages within a web site, by using a software module that is embedded in a web browser rather than in a web page, whereby said module always stays with the browser and remains available for performing the display for different web sites.

5. The method of claim 1 wherein the toolbar can be either horizontal or vertical.

6. A first method for building the address sequence in claim 1, the method comprising:
identifying the address of the web page currently being displayed by the web browser when one of said buttons is pressed;
using the address as the first address in said sequence;
during the process of continuously and consecutively displaying web pages from the first address to the last address in said sequence, scanning the currently displayed web page for hyperlink addresses;
determining whether the hyperlink addresses are within or outside the scope of the first address; and
appending the hyperlinks addresses to said sequence if they are within the scope and are not yet present in said sequence.

7. A second method for building the address sequence in claim 1, the method comprising:
introducing a proprietary tag that is embedded within a web page, said tag containing a list of web page addresses;
during browser navigation, determining whether a web page contains said tag; and
forming said sequence with the addresses contained in said tag if the web page contains said tag.

8. A third method for building the address sequence in claim 1, the method comprising:
storing a list of web page addresses in a predetermined file under a predetermined web server directory;
during browser navigation, determining whether the file exists in the currently visited web site; and
forming said sequence with the addresses contained in the file if the file exists.

9. A method for recording the address sequence in claim 1 for later replay, the method comprising:
saving web page addresses in said sequence to a storage medium;
later, loading the addresses from said medium; and
forming said sequence with the addresses.

10. The method of claim 1 wherein the address sequence is cleared and re-built with a different set of web page addresses for a different web site or for a different entry address within the same web site, whereby a user can switch to watch different web sites or different portions of the same web site.

11. The method of claim 1, further comprising:
providing a text box in said toolbar for a user to enter an index number and jump to a position within said sequence; and
performing an automatic continuous consecutive forward display or backward display for web pages contained in said sequence, starting at the position,

12. The method of claim 1 wherein the equivalent operation for any one of said buttons is alternatively realized by a sound generated by a user.

13. The method of claim 1 wherein the equivalent operation for any one of said buttons is alternatively realized by using a television remote control.

14. The method of claim 1 wherein the equivalent operation for any one of said buttons is alternatively realized by depressing of a key on a key pad.

15. The method of claim 1 wherein the equivalent operation for any one of said buttons is alternatively realized by using a pointing device.
